(19) United States
(12) Patent Application Publication
(10) Pub. No.: US 2008/0152567 A1
(43) Pub. Date: Jun. 26, 2008

(54) GAS ABSORPTION SYSTEM, COMPOSITION, AND METHOD

(76) Inventor: Kerry R. Killough, Houston, TX (US)

Correspondence Address: NALCO COMPANY, 1601 W. DIEHL ROAD, NAPERVILLE, IL, 60563-1198, US

(21) Appl. No.: 11/613,674

(22) Filed: Dec. 20, 2006

(51) Int. Cl. B01D 47/00; B01D 53/50

(52) U.S. Cl. 423/243.01; 423/210; 423/599; 423/605; 96/243; 96/244

(57) ABSTRACT

The present disclosure sets forth an effluent treatment composition, system, and method for the comprehensive treatment of odiferous or noxious effluent formed as a result of an industrial process. The treatment composition includes an oxidant, a biocide, a scale inhibitor, and an anti-foulant agent. The oxidant may be a permanganate composition. A gas absorption system may be used to apply the treatment composition to an odorous effluent to remove primary and secondary odor components from the industrial process.

### BACKGROUND

Many industrial processes generate odiferous gases. In the food production industry for example, the processing of poultry, pork, beef, sheep, and/or fish oftentimes generate large quantities of odorous and/or noxious gases. These gases may be highly offensive to people and may present a serious health concern to areas and communities nearby the odor-generating industrial facility.

Gas absorption systems, otherwise known as wet gas scrubbers or scrubbers, are commonly used to treat odorous gases before these gases enter the atmosphere. Gas absorption systems typically entail a scrubbing tower through which an odorous effluent flows, and a treatment solution that is brought into contact with the odorous effluent in the scrubber. The treatment solution typically contains a masking agent or components capable of removing one or more odor components from the effluent. Conventional effluent treatment solutions, however, oftentimes contain harsh and/or hazardous acids or peroxide-based materials which are problematic when introduced into waste water treatment systems. Moreover, conventional gas absorption systems tend to focus only on the odorous effluent and fail to identify and treat all the odor-producing substances within the system.

### SUMMARY

The present disclosure sets forth an effluent treatment composition, system, and method which provides a multi-pronged approach to the treatment and neutralization of odorous effluent generated from industrial production processes and food production processes in particular. The present disclosure is based on a comprehensive approach to effluent treatment which identifies and addresses all the sources of odor with the gas absorption system.

In an embodiment, a composition is provided. The composition may be used to treat odorous effluent and may include an oxidant, and at least one component selected from a biocide, a scale inhibitor, and an anti-foulant agent. The oxidant may be a permanganate composition such as sodium permanganate, potassium permanganate, and combinations thereof. The biocide may be trichloroisocyanuric acid and derivatives thereof.

In an embodiment, the composition may include the permanganate composition, and at least one component selected from the biocide, the scale inhibitor, and the anti-foulant agent.

In an embodiment, the scale inhibitor may be a carbonate inhibitor, a phosphate inhibitor, and combinations thereof. The anti-foulant agent may be an alkyl polyglycoside.

In an embodiment, the composition may be an aqueous solution and form an effluent treatment solution. The effluent treatment solution may contain from about 75% to about 85% by weight oxidant, from about 5% to about 8% by weight biocide, from about 5% to about 8% by weight scale inhibitor, and from about 5% to about 8% by weight anti-foulant agent. The pH of the aqueous solution may be from about 8 to about 10. The effluent treatment solution may have an oxidation reduction potential greater than about 100 mV.

In an embodiment, a system for treating an odorous effluent is provided. The system includes a chamber with an inlet for receiving the effluent. A spray device may introduce into the chamber droplets of the effluent treatment solution. The effluent treatment solution may include an oxidant, a biocide, a scale inhibitor, and an anti-foulant agent as presented above. Alternatively, the effluent treatment solution may include the permanganate composition and at least one component selected from the biocide, the scale inhibitor, and the anti-foulant agent. The droplets may contact the effluent and remove an odor component from the effluent.

In an embodiment, the droplets may prevent, eliminate, or reduce formation of an obstruction material. The obstruction material may be organic/inorganic material from an industrial production process, as well as mineral deposits, other organic deposits, and/or microorganism growth which may occur within the gas absorption system.

In an embodiment, the chamber may include a column having a fill material. Gaps may be present between the individual pieces of fill material. The effluent and the droplets may pass through the fill material by way of the gaps. The droplets may prevent, eliminate, or reduce the formation of the obstruction material in the gaps.

In an embodiment, the system may include a reservoir for collecting a residual solution from the chamber. A detection device may be placed in operative communication with the residual solution. The detection device may detect a parameter, characteristic, or property of the residual solution. The parameter may be the oxidation reduction potential of the residual solution, the amount of the scale inhibitor in the residual solution, the amount of the biocide in the residual solution, the amount of the anti-foulant agent in the residual solution, and combinations thereof.

In an embodiment, the system may include a source for the oxidant, this oxidant source in fluid communication with the spray device. The detection device may be placed in operative communication with the oxidant source. The detection device may direct the oxidant source to add the oxidant to the effluent treatment solution when the oxidation reduction potential of the residual solution is below a threshold value.

In an embodiment, the system may include a biocide source in fluid communication with the spray device. The detection device may be placed in operative communication with the biocide source. The detection device may direct the biocide source to add the biocide to the effluent treatment solution when the amount of the biocide in the residual solution is below a threshold value.

In an embodiment, the system may include a source for the scale inhibitor, the scale inhibitor source in fluid communication with the spray device. The detection device may be placed in operative communication with the scale inhibitor source The detection device may direct the scale inhibitor source to add the scale inhibitor to the effluent treatment solution when the amount of the scale inhibitor in the residual solution is below a threshold value.

In an embodiment, the system may include a source for the anti-foulant agent, the anti-foulant agent source may be in fluid communication with the spray device. The detection device may be placed in operative communication with the anti-foulant agent source. The detection device may direct the anti-foulant agent source to add the anti-foulant agent to the effluent treatment solution when the amount of the anti-foulant agent in the residual solution is below a threshold value.

In an embodiment, the system may include a biofilter proximate to the effluent outlet, the effluent passing through the biofilter as it exits the gas absorption system.

In an embodiment, a treatment method is provided. The method may treat an odorous effluent and include contacting the odorous effluent with an aqueous solution of the oxidant, biocide, scale inhibitor, and an anti-foulant agent. The contact between the solution and effluent removes one or more odor components from the effluent. The method may include spraying the effluent treatment solution as droplets onto/into the stream of the effluent to maximize the contact area between the solution stream and the effluent stream.

In an embodiment, the treatment method may include contacting the odorous effluent with an aqueous solution of the permanganate composition and at least one component selected from the oxidant, the biocide, the scale inhibitor, and the anti-foulant agent. The contact between the solution and effluent removes one or more odor components from the effluent.

In an embodiment, the method may include the prevention, elimination or removal of the obstruction material from the internal surfaces of the gas absorption system. The method may further include the prevention, elimination or removal of a secondary odor component from the effluent and/or the gas absorption system.

In an embodiment, the method may include contacting the odorous effluent with droplets of the effluent treatment solution, removing an odor component from the effluent, collecting a residual solution, and determining a parameter of the residual solution. As discussed above, the parameter may be the oxidation reduction potential of the residual solution, the amount of biocide in the residual solution, the amount of scale inhibitor in the residual solution, the amount of anti-foulant agent in the residual solution, and combinations thereof. The method may entail adding a component of the effluent treatment composition to the effluent treatment solution when a parameter in the residual solution corresponding to the component falls below a threshold value.

It is an advantage of the present disclosure to identify and treat all, or substantially all, the sources of odor present in a gas absorption treatment system.

It is an advantage of the present disclosure to provide a comprehensive effluent treatment composition, system, and method which identifies and remedies the compounding of odor components which occurs in gas absorption systems used to treat effluent emanating from an animal production process.

It is an advantage of the present disclosure to identify and treat primary odor components from an industrial process as well as identify and treat secondary odor components that develop in the industrial system during the treatment of the odorous effluent

It is an advantage of the present disclosure to provide an effluent treatment composition, system, and method which maintains the structural integrity of the gas absorption system by preventing, eliminating, or reducing the formation of obstruction material on the inner surfaces of the effluent treatment system.

It is an advantage of the present disclosure to provide an effluent treatment system which reduces industrial production downtimes by preventing, eliminating, or reducing the formation of obstruction material within the system thereby increasing production efficiencies, production economies, and production output.

Additional features and advantages are described herein, and will be apparent from, the following Detailed Description and the figures.

### BRIEF DESCRIPTION OF THE FIGURES

FIG. 1 is schematic representation of an odor-generating industrial production process in accordance with an embodiment of the present disclosure.

FIG. 2 is a schematic representation of a gas absorption system in accordance with an embodiment of the present disclosure.

### DETAILED DESCRIPTION

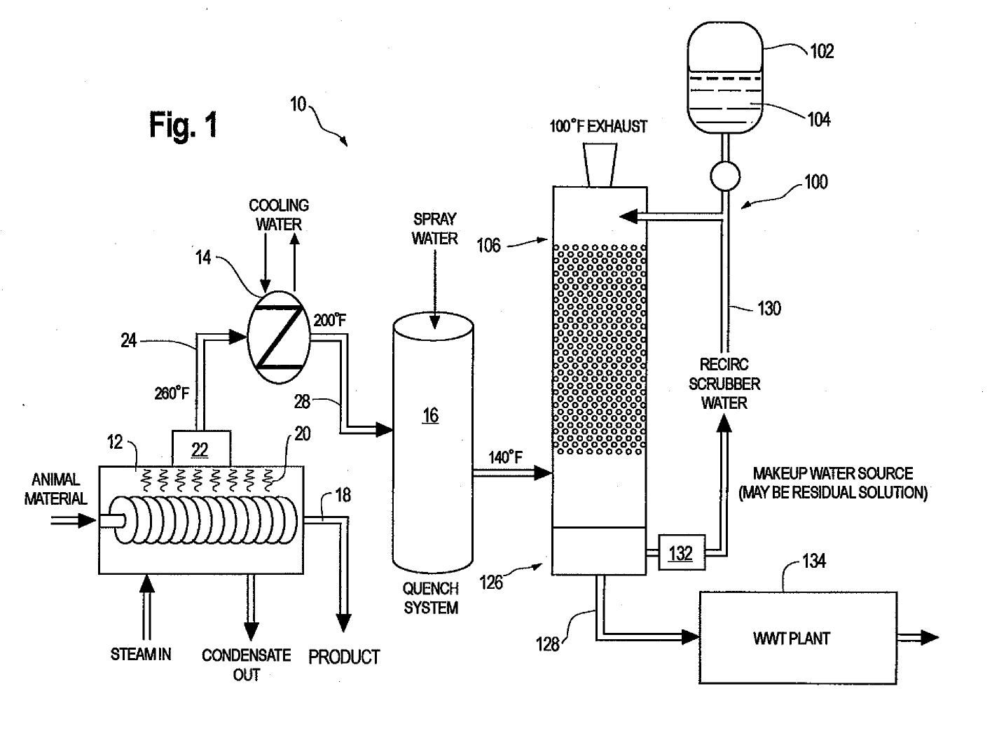

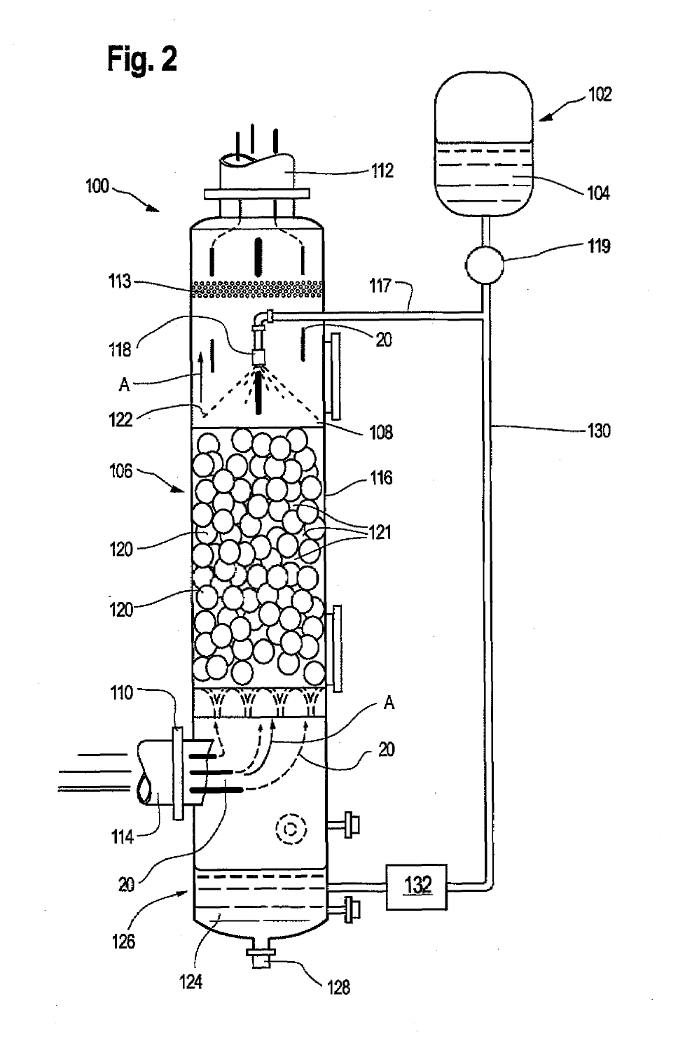

Referring to the Figures generally, where like reference numerals denote like structure and elements, and in particular to FIGS. 1-2, a schematic representation of an industrial production process is shown. The industrial production process may be any production process that emits or otherwise generates an odorous or noxious gas. Nonlimiting examples include animal processing, food processing, chemical processing, and paint production. In an embodiment, the industrial production process may be a rendering production system 10 and may include a rendering device 12, a cooling device 14, a pre-scrubbing device 16, and a gas absorption system 100.

Rendering is an industrial process that converts waste animal tissue into stable, value-added materials. Animal material processed by rendering device 12 may originate from slaughterhouses, supermarkets, restaurants, and butcher shops, for example. The animal material may include the blood, feedstock, fatty tissue, bones, and offal, as well as entire carcasses of animals condemned at slaughterhouses, and those that have died on farms (deadstock), or in transit etc. Nonlimiting examples of the animal material may be any component of beef, pork, sheep, poultry, and/or fish.

Rendering device 12 cooks the animal material at elevated temperature as is commonly known in the art. In an embodiment, the rendering device 12 may be a steam jacketed vessel which boils the animal material, removes excess water, and forms a concentrated solid or semi-solid product. The product may be fat, animal solids, and combinations thereof. The product may be collected from the rendering device 12 by way of conduit 18. The product may be an edible and/or a non-edible product and may be further processed as is commonly known in the art. Nonlimiting examples of products produced by rendering device 12 include tallow, lard, grease, and protein meal.

The released vapors from the rendering process form an effluent 20. The effluent 20 may be drawn through the system 10 by maintaining a partial vacuum on the rendering device 12 by way of a temperature differential. The effluent 20 may be a combination of solid, liquid, and gaseous components resulting from the rendering process. In an embodiment, the effluent 20 (or odorous effluent) may be a gas with water vapor and/or solid particles dispersed therein. For example, the effluent may include organic particles of animal material, water droplets or water vapor containing dispersed/dissolved solids of animal material, and gas from the animal material or by-products thereof. The effluent 20 may also include an odor component originating from the animal material. Nonlimiting examples of the odor component include sulfides (organic and inorganic), thiols (such as mercaptans), alcohols, carboxylic acids, phenols, nitrogen-based compounds (i.e., ammonia/amines), proteins and combinations thereof. It is understood that the effluent 20 be the result of any process which generates an odorous and/or a noxious gas. Although a rendering production process is herein described, one of ordinary skill in the art would understand that the effluent 20 may emanate from other nonlimiting processes such as a food production process, a chemical production process, or other industrial production processes which generate an odorous or noxious effluent.

In an embodiment, the rendering device 12 may discharge the effluent 20 into an outlet 22. The effluent 20 moves from the outlet 22 through a conduit 24 to a cooling device 14. The conduit 24 may be any duct, tubing, piping or the like capable of receiving and transporting the effluent 20 from one point to another. Upon exit from the outlet 22, the effluent may be at a temperature of about 240° F. to about 280° F., or about 260° F. The cooling device 14 may lower the temperature of the effluent 20 by about 50° F.-100° F. (i.e., from about 260° F. to about 180° F.-220° F.). In an embodiment, the temperature of the effluent 20 when exiting the cooling device 14 is about 200° F. In a further embodiment, the cooling device 14 may be a heat exchanger, such as a shell and tube unit or the like, and may include a condensing member (not shown) as is commonly known in the art. In an embodiment, cooling water passed through the condensing member may be waste water effluent, potable water going to a plant or a pre-boiler system, or “once through” water which moves to a waste water system.

In an embodiment, the effluent 20 moves from the cooling device 14, through a conduit 28 to the pre-scrubbing device 16. The pre-scrubbing device 16 may include an air misting system (alone or in combination with a condensing system) to quench or otherwise further lower the temperature of the effluent 20. The air misting system may also remove solids or particulate from the effluent 20. In an embodiment, the pre-scrubbing device 16 lowers the temperature of the effluent 20 to about 120° F. to about 160° F. or to about 140° F. Nonlimiting examples of suitable quenching units include parabolic exchangers, air-to-air exchangers, or a system that combines the high air gases and the room air gases to cool the effluent 20. In an embodiment, the quench unit may be a component of the effluent treatment system 100 and may be a multiple stage system. In yet a further embodiment, the cooling water used in pre-scrubbing device 16 may be a once through configuration.

In an embodiment, the gas absorption system 100 (also known as a wet gas scrubber, or scrubber) may include a source 102 of an effluent treatment composition 104 and a scrubbing device 106 as shown in FIGS. 1 and 2. The scrubbing device 106 may include a chamber 108 with an effluent inlet 110 and an effluent outlet 112. A conduit 114, such as tubing, piping, a duct, or the like, may place the pre-scrubbing device 16 in fluid communication with the effluent inlet 110 for introducing the effluent 20 into the scrubbing device 106. The effluent 20 enters the chamber 108 through the effluent inlet 110, moves through chamber 108 in an upstream direction as indicated by direction arrow A in FIG. 2, and exits the chamber 108 through the effluent outlet 112.

In an embodiment, the scrubbing device 106 may include a column 116 and a spray device 118 in fluid communication with the source 102 by way of a conduit 117. A regulating device 119 may be used to meter the amount of the effluent treatment composition 104. The regulating device 119 may also be used to meter and introduce the effluent treatment composition 104 with water to form an aqueous effluent treatment solution. Thus, the regulating device 119 may precisely dose the amount of treatment composition/solution that enters the chamber 108. The column 116 may be packed with a fill material 120. The fill material 120 may be any inert material that does not react with the effluent 20 and/or the effluent treatment composition 104 as is commonly known in the art. Nonlimiting examples of suitable materials for fill material 120 include polymeric material such as polyvinyl chloride. Gaps 121 are located between the pieces of fill material 120. In an embodiment, the spray device 118 delivers an aqueous solution of the effluent treatment composition 104 into the column 116 as droplets 122. In other words, the spray device 118 increases or maximizes the surface area of the effluent treatment solution. The droplets 122 may be a fine spray, a mist, or atomized particles (visible or non-visible to the naked eye) of the effluent treatment composition 104.

The droplets 122 pass through the column 116, the droplets 122 being further dispersed upon contact and impingement with the fill material 120. Thus, the spray device 118 and the fill material 120 operate in conjunction to maximize the surface area of the effluent treatment composition 104 as in a downstream direction through the chamber 108. Similarly, the effluent 20 is dispersed as it contacts and impinges the fill material 120 as the effluent 20 proceeds in the upstream direction through the chamber 108. This results in a maximized contact area between the effluent treatment composition 104 and the effluent 20. The opposing flows between the downstream moving droplets 122 and the upstream moving effluent 20 results in a turbulent interaction of these two streams which removes or “scrubs” any solid particulate from the effluent 20. In an embodiment, this solid particulate may be removed from the column 116 by blowdown. As the droplets 122 and the effluent 20 contact and interact, gases, odor components, organic/inorganic material, and/or microorganisms present in the effluent 20 may be absorbed, adsorbed, solubilized, reduced, or otherwise dissolved by the droplets 122. Thus the effluent treatment composition 104 may remove an odor component and other material from the effluent 20.

In an embodiment, the droplets 122 may be collected as a residual solution 124 in a reservoir 126 located at the bottom of the chamber 108 after contact between the droplets 122 and the effluent 20. Some or all of the residual solution 124 may be discharged through a drain 128 for treatment at a waste water treatment plant 134 as is commonly known in the art. Alternatively, some or all of the residual solution 124 may be re-introduced or otherwise recycled back into the chamber 108, through spray device 118 by way of conduit 130.

Gas absorption systems are used in conjunction with a variety of production applications. In animal processing applications in particular, the effluent contains significant amounts of organic material and odor components. The organic materials contained in the gas stream, the elevated temperature of the system, minerals in the water, and the water pH may lead to rapid evolution of microorganism growth within the gas absorption system. Thus, obstruction material such as organic material, mineral deposits, and microorganism growth has a tendency to collect on the surfaces of the gas absorption system. These materials may clog or impede the nozzles or outlets of the spray device 118 and the gaps 121 between the fill material 120. Accumulation of this obstruction material on the interior surfaces of the column and the chamber deleteriously impacts the operation and efficiency of the gas absorption system. In addition, presence of the organic material at elevated temperature within the effluent 20 further yields a prime environment for microorganism breeding and growth upon the internal surfaces of the gas absorption system 100. This microbiological growth may cause fouling of the fill material 120, obstruction within the gaps 121, clogging of the spray device 118, and may lead to deposit on and/or corrosion to exposed metal surfaces of the system.

Similarly, scale deposits degrade the interface between the droplets 122 and the effluent 20. Scale deposits reduce the contact area between the droplets 122 and the effluent 20 by obstruction or filling the gaps 121 between the fill material 120. Scale deposits further promote microorganism growth within the gas absorption system 100 by providing a substrate conducive to microorganism breeding. Not only do mineral deposits and microorganism growth obstruct and impede the operation and efficiency of the gas scrubber system 100, each may be the source of a secondary odor component. The secondary odor component may be an odorous or noxious gas which emanates from the deposits and/or microorganism growth within the gas absorption system 100. In particular, the secondary odor component may be an odor from mineral deposits, organic deposits, microorganism growth (including slime and bacteria accumulation), and combinations thereof. In other words, the gas absorption system may contribute to the generation of odor—the very problem the gas absorption system was intended to alleviate. This compounding of the odor problem within the treatment system itself is all too often overlooked in conventional odorous effluent treatment systems.

The effluent treatment composition 104 advantageously provides a comprehensive solution to the compounding odor problems associated with wet gas scrubbing of the effluent emanating from animal processing. In particular, the effluent treatment composition 104 may include an oxidant and at least one of a biocide, a scale inhibitor, and an anti-foulant agent. These components work synergistically to reduce, substantially eliminate, eliminate, or prevent: 1) odor components present in the effluent; 2) the formation of scale deposits upon surfaces of the gas absorption system; 3) the formation of microorganisms and concomitant secondary odor components within the gas absorption system; and 4) the growth of microorganisms on the internal surfaces of the gas absorption system. This comprehensive approach to odorous effluent treatment advantageously identifies and addresses the compounding odor problem which is ignored by conventional effluent treatment systems.

The oxidant may be any material or composition that removes or otherwise reduces an odor component from the effluent 20. In other words, the oxidant reduces the odorous or noxious gases solubilized in the droplets 122. The oxidant may also remove or reduce any organic particulate material present in the effluent 20. Thus, the presence of the oxidant in the effluent treatment composition 104 advantageously enables the droplets 122 to capture and remove small organic particles present in the effluent 20 that may otherwise pass through the column 116 and through effluent outlet 112. In an embodiment, the oxidant may also prevent biological growth within the chamber 108, on the spray device 118, within column 116 on the surfaces of the fill material 120 and within gaps 121.

In an embodiment, the oxidant may be a permanganate composition. Nonlimiting examples of suitable permanganate compositions include sodium permanganate, potassium permanganate, and combinations thereof. Permanganate compositions have been found to be effective in the reduction/elimination of volatile organic compounds (VOC) such as phenols, sulfides, and mercaptans. The permanganate composition advantageously reduces or otherwise neutralizes the odor component while yielding a mild reaction product (MnO/MnO₂) which is readily handled by municipal waste water treatment systems. Not wishing to be bound by any particular theory, it is believed that the permanganate reaction may be exemplified as follows.

VOC+MnO₄→MnO₂+oxidation co-products (alcohols).

Permanganate compositions have been found to be effective in the reduction of sulfur-based odors and hydrogen sulfide odors in particular. Not wishing to be bound by any particular theory, it is believed the reaction between permanganate and hydrogen sulfide occurs as follows.

H₂S+4 NaMnO₄→2NaSO₄+S+3MnO+MnO₂+3H₂O

The effluent treatment composition may be an aqueous solution as previously discussed. It has been found that maintaining the aqueous solution at a basic pH optimizes the ability of the permanganate composition to react with odor components. In an embodiment, the pH of the effluent treatment composition solution may be from about 8 to about 10, or any value therebetween. In an embodiment, the pH of the aqueous solution may be about 9.

In a further embodiment, the permanganate composition may be present in an amount to provide an effluent treatment solution with an oxidation reduction potential (ORP) of from about 100 mV to about 250 mV or any value therebetween. In a further embodiment, the effluent treatment solution may have an ORP greater than about 100 mV or greater than about 150 mV.

The biocide of the effluent treatment composition 104 may attack and destroy any microorganism growth which may occur within the gas absorption system 100. The biocide may be a halogen-based biocide which readily oxidizes in aqueous solution. In an embodiment, the biocide may release hypochlorous acid into the aqueous solution which may quickly convert to hypobromous acid. Hypobromous acid is known to be an effective biocide when the system pH is above 7.5, and when nitrogen-based contaminants/odorants (i.e., ammonia/amines) are present. In an embodiment, the biocide may include trichloroisocyanuric acid or a derivative thereof. In a further embodiment, the biocide may include about from about 92% to about 93% by weight sodium dichloro-s-triazinetrione (trichloroisocyanuric acid) and from about 7% to about 8% by weight sodium bromide with an available chlorine content of about 57% by weight. In an embodiment the biocide may include trichloro-s-triazinetrione (trichloroisocyanuric acid) present in amount from about 92% to about 93% by weight, sodium bromide present from about 7% to about 8% by weight with an available chlorine content of about 83% by weight.

The scale inhibitor of the effluent treatment composition 104 may prevent, reduce, and/or eliminate mineral deposits on the internal surfaces of the chamber 108. In addition, the scale inhibitor may prevent, reduce, and/or eliminate the formation of mineral deposits within the gaps 121 between the fill material 120. In an embodiment, the scale inhibitor may be any composition or material, such as a carbonate inhibitor or a phosphate inhibitor, for the control of calcium carbonate deposit, and/or calcium phosphate deposit, and/or suspended solids deposition as is commonly known in the art. Nonlimiting examples of suitable scale inhibitors include anionic polymer, high stress polymer, and combinations thereof. Suitable scale inhibitors include Nalco 23252, Nalco 3DT190, Nalco 23263, Nalco 73201, and Nalco 5200M, available from The Nalco Company, Naperville, Ill.

The anti-foulant agent of the effluent treatment composition 104 may be any material or composition for removing and/or dispersing microorganisms or microbiological-based slime and silt deposits as is commonly known in the art. The anti-fouling agent may prevent, reduce, substantially eliminate, or eliminate microbiological growth within the gas absorption system 100 which causes fouling of the fill material 120, fouling of nozzles/outlets of the spray device 118, obstruction of gaps 121, or may otherwise lead to deposit and/or corrosion on exposed metal surfaces of the system. In an embodiment, the anti-foulant agent may be a non-ionic bio-detergent which disrupts biofilm integrity, removes surface deposits and facilitates biocide penetration into slime. In a further embodiment, the anti-foulant agent may remove surface deposits of microorganisms through a combination of chemical solubilization and physical scrubbing of entrained air bubbles. Nonlimiting examples of suitable anti-foulant agents include alkyl polyglycosides and blends thereof. Suitable anti-foulant agents include Nalco 73550, Nalco 73551 and combinations thereof, available from The Nalco Company, Naperville, Ill. The presence of the anti-fouling agent in the effluent treatment composition 104 advantageously improves the cleanliness within the gas absorption system, improving the operation thereof. The anti-fouling agent also synergistically effects the oxidant as the presence of the anti-fouling agent requires less oxidant in the effluent treatment composition 104.

In an embodiment, the effluent treatment composition 104 may be an aqueous solution (or an effluent treatment solution) containing from about 75% to about 85% percent by weight oxidant, from about 5% to about 8% biocide, from about 5% to about 8% by weight scale inhibitor, and from about 5% to about 8% by weight anti-foulant agent. In a further embodiment, the aqueous solution may contain about 80% by weight oxidant, about 7% by weight biocide, about 7% by weight scale inhibitor, and about 6% by weight anti-foulant agent. In a further embodiment, the aqueous solution may contain from about 15 ppm to about 35 ppm oxidant, from about 0.5 ppm to about 1.5 ppm biocide, from about 5 ppm to about 35 ppm scale inhibitor, and from about 5 ppm to about 25 ppm anti-foulant agent.

After interaction and contact with the droplets 122, the effluent 20 may proceed through the chamber 108, move past the spray device 118, and move toward the effluent outlet 112. A biofilter 113 may be located at the outlet end of the chamber 108, the effluent 20 passing through the biofilter 113 and out through the effluent outlet 112. The biofilter 113 may capture or otherwise retain any odor components and/or particulates that may happen to pass through chamber 108 without being treated.

In an embodiment, the gas absorption system 100 may have a cleaning capacity of from about 50,000-100,000 CFM. Such a system is typically applied to a large volume industrial production process. Alternatively, the gas absorption system may be a small-scale system tailored for one or more rooms, the small-scale system having a capacity of from about 5,000-10,000 CFM. The gas absorption system may remove from about 90% to about 99% or more of all the odor components present in the effluent 20. In an embodiment, the gas absorption system 100 may remove from about 99% to about 99.999% of all odor components (both primary and secondary) of all odor components present in the industrial production process.

The residual solution 124 may be considered the effluent treatment solution after contact with the effluent 28. In an embodiment, the residual solution 124 may be wholly or partially saturated with organic, inorganic waste materials and/or reduction products as result of the contact and interface between the droplets 122 and the effluent 20 in the chamber 108. A conduit 130 may be used to recirculate or otherwise recycle none, some, or all of the residual solution 124 back into the chamber 108 by way of the spray device 118. A pump or other flow regulation device may be used to recycle the residual solution 124 back into the chamber 108 as is commonly known in the art.

In an embodiment, the gas absorption system 100 may include a feedback system for precise dosing of the effluent treatment composition 104. A detection device 132 may be placed in operative communication with the residual solution 124 as shown in FIG. 2. Detection device 132 may be any device capable of detecting or otherwise determining the parameters or properties of the residual solution 124 as is commonly known in the art. For example, the detection device 132 may detect the oxidation reduction potential of the residual solution, the amount of the scale inhibitor present in the residual solution, the amount of the biocide present in the residual solution, the amount of the anti-foulant agent present in the residual solution, and combinations thereof. In addition, the detection device 132 may detect the pH of the residual solution. Detection of each parameter may be continuous or intermittent as desired.

In an embodiment, the detection device 132 may be capable of detecting and/or determining the ORP of the residual solution 124.

In an embodiment, the detection device 132 may be in operative communication with a source for each effluent treatment component (i.e., oxidant, biocide, scale inhibitor, and anti-foulant agent). Although FIG. 2 shows a single source 102, it is understood that the gas absorption system 100 may include a discrete or dedicated source for each component of the effluent treatment composition 104. For example, the detection device 124 may be in operative communication with a dedicated regulating device 119 for each component, (such as a valve, a meter or the like), the regulating device 119 regulating and/or metering the amount of each individual component introduced into the conduit 117 for delivery to the spray device 118.

In an embodiment, the detection device 132 may be in operative communication with an oxidant source, the oxidant source in fluid communication with the spray device 118. The detection device may continuously or intermittently detect the ORP of the residual solution 124. In the event the ORP falls below a threshold value, the detection device 132 may direct the oxidant source to deliver an amount of the oxidant to the effluent treatment solution. The oxidant may be delivered to the effluent treatment solution until the ORP of the residual solution 124 is equal to or above the threshold value. In an embodiment, the detection device 124 directs the oxidant source to deliver the oxidant to the aqueous solution when the ORP of the residual solution is below about 250 mV, or below about 200 mV, or below about 150 mV, or below about 100 mV.

In an embodiment, the detection device 132 may be in operative communication with the biocide source, the detection device 132 directing the biocide source to add the biocide to the effluent treatment solution when the amount of the biocide in the residual solution is below a threshold value.

In an embodiment, the detection device 132 may be in operative communication with the scale inhibitor source. The detection device 132 may direct the scale inhibitor source to add the scale inhibitor to the effluent treatment solution when the amount of the scale inhibitor in the residual solution is below a threshold value.

In an embodiment, the detection device 132 may be in operative communication with the anti-foulant agent source, the detection device directing the anti-foulant agent source to add the anti-foulant agent to the effluent treatment solution when the amount of the anti-foulant agent in the residual solution is below a threshold value. This feedback system advantageously provides real-time analysis of the conditions within the gas absorption system 100. The feedback system provides for the precision dosing of each individual component of the effluent treatment composition 104. The feedback system advantageously provides responsive, efficient, economic, precise dispensing of each individual component yielding a dynamic effluent treatment system.

In an embodiment the system 100 may include the reservoir 126 with the residual solution 124 contained therein. The residual solution 124 may be formed or otherwise result from contact between the effluent 20 and the treatment solution as previously discussed. The treatment solution may contain the scale inhibitor having a tracing agent. The treatment solution may further include at least one component selected from the oxidant, the biocide, and the anti-foulant agent. In an embodiment, the treatment solution includes the scale inhibitor with a tracing agent, the permanganate composition, the biocide, and the anti-foulant agent. The detection device 132 may then be used to detect the presence of the tracing agent in the residual solution 124.

In an embodiment, the tracing agent may include a fluorescent moiety. Fluorescent moieties may be fluorescent tagged polymers; in one embodiment the scale inhibitor is a polymer with a fluorescent moiety. A discussion of the use of fluorescent tagged polymers in industrial water systems is described in U.S. Pat. No. 5,171,450 “Monitoring and Control of Tagged Polymers in Cooling Water Systems”, which is herein incorporated by reference. The tracing agent permits measurement and control of the amount and the concentration of the treatment solution added to the system. This may be accomplished by measuring the fluorescence (or fluorescent emissivity) of the tracing agent in residual solution 124 and comparing it to a standard solution of the tracing agent. Detection of the tracing agent may be continuous or intermittent as desired.

In an embodiment, the detection device 132 may include a fluorometer and a light source. Exposing the residual solution 124 to the light source may excite each tracing agent causing the tracing agent to emit fluorescent light. The detection device 132 may include a light receiver, such as the fluorometer, which detects the emitted light from the tracing agent. The detection device 132 may having a control device or suitable logic to correlate the fluorescence to the amount/concentration of the scale inhibitor present in the residual solution 124. Thus, the detection device 132 may quantify the amount of the scale inhibitor present in the residual solution 124 based on the amount of fluorescent light emitted by the tracing agent.

In an embodiment, the system 100 may include a scale inhibitor source in operative communication with the detection device 132 as previously discussed. The detection device 132 may direct the scale inhibitor source to add the scale inhibitor to the treatment solution when the amount of the tracing agent in the residual solution is below a predetermined value.

The antifoulant agent may be slaved to the scale inhibitor. In an embodiment, the system 100 may include an antifoulant agent source in operative communication with the detection device. The detection device may direct the antifoulant agent source to add the antifoulant agent to the treatment solution when the amount of the tracing agent in the residual solution is below a predetermined value. The proportion by which the antifoulant agent is added with the scale inhibitor may be adjusted as desired. For example, the antifoulant agent may be slaved to a 1:1 by weight percent proportion with the scale inhibitor. Alternatively, the antifoulant agent may be added to the effluent treatment solution in a predetermined proportion (weight proportion, concentration proportion) with respect to the amount of the added scale inhibitor.

In an embodiment, a method for treating an odorous effluent is provided. The method includes contacting the odorous effluent with an aqueous solution of the effluent treatment composition 104. The effluent treatment composition includes the oxidant, and at least one component selected from the biocide, the scale inhibitor, and the anti-foulant agent as previously discussed. The method further includes removing with the aqueous solution an odor component from the effluent. The odor component may be a result of the industrial production process (also known as the primary odor components) and may include a component such as sulfides, thiols, alcohols, carboxylic acids, phenols, nitrogen-based compounds, proteins, and combinations thereof.

In an embodiment, the method may include providing the chamber 108, introducing the effluent 20 into an end of the chamber, and spraying the droplets 122 (by way of the spray device 118) of the effluent treatment solution into an opposing end of the chamber 108. The droplets 122 may prevent, eliminate, and/or remove an obstruction material from the chamber 108. The obstruction material may be organic/inorganic material/deposits, mineral deposits, organic deposits, microorganism growth, and combinations thereof as previously discussed herein. The droplets 122 may prevent eliminate, and/or remove this obstruction material from the gaps 121 between the fill material 120.

In an embodiment, the droplets 122 may prevent, eliminate, and/or remove a secondary odor component from the system 100 or from the chamber 108. The secondary odor component may include a microorganism odor, a mineral deposit odor, and combinations thereof as previously discussed herein.

In an embodiment, the method may include passing the effluent through the biofilter 113.

In an embodiment, a treatment method is provided. The method may include contacting the odorous effluent 20 with droplets of an aqueous solution of the effluent treatment composition, removing with the aqueous solution an odor component from the effluent and collecting the residual solution 124. Collection of the residual solution 124 may occur after one or more odor components or other materials have been removed from the effluent 20. The method may further include determining a parameter of the residual solution. The parameter may be the oxidation reduction potential of the residual solution, the amount of biocide in the residual solution, the amount of scale inhibitor in the residual solution, the amount of anti-foulant agent in the residual solution, and combinations thereof.

In an embodiment, the method may include adding the oxidant to the effluent treatment solution when the oxidation reduction potential of the residual solution is below a threshold value. Similarly, the method may entail adding the biocide to the effluent treatment solution when the amount of the biocide in the residual solution is below a threshold value.

The method may include adding the scale inhibitor to the aqueous solution when the amount of scale inhibitor in the residual solution is below a threshold value. The method may further include adding the anti-fouling agent to the aqueous solution when the amount of the anti-fouling agent in the residual solution is below a threshold value.

In an embodiment a further treatment method is provided. The method includes contacting the effluent 20 with the effluent treatment solution The effluent treatment solution may include a scale inhibitor having a tracing agent. The effluent treatment solution may also include at least one component selected from the oxidant (the permanganate composition), the biocide, and the anti-foulant agent. The method may further include removing with the aqueous treatment solution an odor component from the effluent and collecting the residual solution. The method may further entail determining the amount of tracing agent present in the residual solution.

The tracing agent may be fluorescent or contain a fluorescent moiety as previously discussed. The method may further include measuring the fluorescence of the tracing agent and correlating the fluorescence to the amount of scale inhibitor present in the residual solution. The method may the entail adding the scale inhibitor to the treatment solution when the amount of the scale inhibitor present in the residual solution falls below a predetermined value.

In an embodiment, the antifoulant agent may be slaved to the scale inhibitor as previously discussed. The method may include adding the antifoulant agent to the treatment solution when the amount of the scale inhibitor is below the predetermined value.

By way of example and not limitation, examples of the present disclosure will now be given.

### EXAMPLE 1

### Stand Alone Treatment

| Chemical | Purpose | Dose [ppm] | Control |
|---|---|---|---|
| Permanganate | Oxidant | 20–30 | ORP |
| Nalco 991 | Slime | 1.0 | Free residual |
| Nalco 73550/73551 | Bio dispersant | 5–20 | |
| Nalco 5200M | Fill cleanliness | 10–30 | |
| Nalco 9351 | Fill cleanliness | 10–30 | |

### EXAMPLE 2

### Trace Polymer, Slave Feed Biodispersant TRASAR 3000 or 3DT Light Controller

| Chemical | Purpose | Dose [ppm] | Control |
|---|---|---|---|
| Permanganate | Oxidant | 20–30 | ORP |
| Nalco 991 | Slime | 1.0 | Free residual |
| Nalco 73550/73551 | Bio dispersant | 5–20 | Slaved Feed |
| Nalco 23252 | Fill cleanliness | 10–30 | TRASAR |
| Nalco 23257 | Fill cleanliness | 10–30 | TRASAR |

### EXAMPLE 3

### Trace Polymer, Slave Feed Biodispersant, Use TRASAR monitored ORP and Tubidity TRASAR 3DT Controller

| Chemical | Purpose | Dose [ppm] | Control |
|---|---|---|---|
| Permanganate | Oxidant | 20–30 | TRASAR-ORP |
| | | | Residual |
| Nalco 991 | Slime | 1.0 | Free residual |
| Nalco 73550/73551 | Bio dispersant | 5–20 | Slaved Feed |
| Nalco 23252 | Fill cleanliness | 10–30 | TRASAR |
| 3DT190 or 23263 or | Fill cleanliness | 10–30 | TRASAR |
| 73201 | | | |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A composition comprising:
a permanganate composition; and
at least one component selected from the group consisting of a biocide,
a scale inhibitor, and an anti-foulant agent.

2. The composition of claim 1 wherein the permanganate composition is selected from the group consisting of sodium permanganate, potassium permanganate, and combinations thereof.

3. The composition of claim 1 wherein the biocide is selected from the group consisting of trichloroisocyanuric acid and derivatives thereof.

4. The composition of claim 1 wherein the scale inhibitor is selected from the group consisting of a carbonate inhibitor, a phosphate inhibitor, and combinations thereof.

5. The composition of claim 1 wherein the anti-foulant agent is an alkyl polyglycoside.

6. The composition of claim 1 wherein the composition is an aqueous solution.

7. The composition of claim 6 wherein the aqueous solution contains from about 75% to about 85% by weight permanganate composition, from about 5% to about 8% by weight biocide, from about 5% to about 8% by weight scale inhibitor, and from about 5% to about 8% by weight anti-foulant agent.

8. The composition of claim 6 wherein the pH of the aqueous solution is from about 8 to about 10.

9. The composition of claim 6 wherein the oxidation reduction potential of the solution is greater than about 100 mV.

10. A treatment method comprising:
contacting an effluent with an aqueous solution comprising a permanganate composition and at least one component selected from the group consisting of a biocide, a scale inhibitor, and an anti-foulant agent; and
removing with the aqueous solution an odor component from the effluent.

11. The method of claim 10 wherein the odor component is selected from the group consisting of sulfides, thiols, alcohols, carboxylic acids, phenols, nitrogen-based compounds, proteins, and combinations thereof.

12. The method of claim 10 further comprising
providing a chamber;
introducing the effluent into an end of the chamber; and
spraying droplets of the solution into an opposing end of the chamber.

13. The method of claim 12 further comprising removing with the droplets an obstruction material from the chamber, the obstruction material selected from the group consisting of mineral deposits, organic deposits, microorganism growth, and combinations thereof.

14. The method of claim 12 wherein the chamber further comprises a fill material with gaps therebetween, the method further comprising removing with the droplets an obstruction material from the gaps, the obstruction material selected from the group consisting of mineral deposits, organic deposits, microorganism growth, and combinations thereof.

15. The method of claim 12 wherein the chamber further comprises a secondary odor component, the method further comprising removing with the droplets the secondary odor component from the chamber.

16. The method of claim 15 wherein the secondary odor component is selected from the group consisting of a microorganism odor, a mineral deposit odor, and combinations thereof.

17. The method of claim 12 further comprising determining the amount of microorganism growth in the chamber and adding the anti-fouling agent to the solution when the microorganism growth exceeds a threshold value.

18. The method of claim 10 further comprising passing the effluent through a biofilter.

19. A treatment method comprising:
contacting an odorous effluent with droplets of an aqueous solution comprising an oxidant, a biocide, a scale inhibitor, and an anti-foulant agent;
removing with the aqueous solution an odor component from the effluent;
collecting a residual solution; and
determining a parameter of the residual solution, the parameter selected from the group consisting of the oxidation reduction potential of the residual solution, the amount of biocide in the residual solution, the amount of scale inhibitor in the residual solution, the amount of anti-foulant agent in the residual solution, and combinations thereof.

20. The method of claim 19 further comprising adding the oxidant to the aqueous solution when the oxidation reduction potential of the residual solution is below a threshold value.

21. The method of claim 19 further comprising adding the biocide to the aqueous solution when the amount of the biocide in the residual solution is below a threshold value.

22. The method of claim 19 further comprising adding the scale inhibitor to the aqueous solution when the amount of scale inhibitor in the residual solution is below a threshold value.

23. The method of claim 19 further comprising adding the anti-fouling agent to the aqueous solution when the amount of the anti-fouling agent in the residual solution is below a threshold value.

24. A system comprising:
a chamber with an inlet for receiving an effluent;
a spray device introducing into the chamber droplets of an effluent treatment solution comprising a permanganate composition and at least one component selected from the group consisting a biocide, a scale inhibitor, and an anti-foulant agent; and
the droplets contacting the effluent and removing an odor component from the effluent.

25. The system of claim 24 wherein the permanganate composition is selected from the group consisting of sodium permanganate, potassium permanganate, and combinations thereof.

26. The system of claim 24 wherein the droplets prevent formation of an obstruction material within the chamber, the obstruction material selected from the group consisting of mineral deposits, organic deposits, microorganism growth, and combinations thereof.

27. The system of claim 24 wherein the chamber further comprises a column having a fill material with gaps through which the effluent and the droplets pass, the droplets preventing the formation of an obstruction material in the gaps, the obstruction material selected from the group consisting of mineral deposits, organic deposits, microorganism growth, and combinations thereof.

28. The system of claim 24 further comprising a reservoir for collecting a residual solution from the chamber and a detection device in operative communication with the residual solution, the detection device detecting a parameter selected from the group consisting of the oxidation reduction potential of the residual solution, the amount of the scale inhibitor in the residual solution, the amount of the biocide in the residual solution, the amount of the anti-foulant agent in the residual solution, and combinations thereof.

29. The system of claim 28 further comprising an oxidant source in fluid communication with the spray device, the detection device in operative communication with the oxidant source, the detection device directing the oxidant source to add the oxidant to the effluent treatment solution when the oxidation reduction potential is below a threshold value.

30. The system of claim 28 further comprising a biocide source in fluid communication with the spray device, the detection device in operative communication with the biocide source, the detection device directing the biocide source to add the biocide to the effluent treatment solution when the amount of the biocide in the residual solution is below a threshold value.

31. The system of claim 28 further comprising a scale inhibitor source in fluid communication with the spray device, the detection device in operative communication with the scale inhibitor source, the detection device directing the scale inhibitor source to add the scale inhibitor to the effluent treatment solution when the amount of the scale inhibitor in the residual solution is below a threshold value.

32. The system of claim 28 further comprising an anti-foulant agent source in fluid communication with the spray device, the detection device in operative communication with the anti-foulant agent source, the detection device directing the anti-foulant agent source to add the anti-foulant agent to the effluent treatment solution when the amount of the anti-foulant agent in the residual solution is below a threshold value.

33. The system of claim 24 wherein the chamber further comprises an effluent outlet and a biofilter proximate to the effluent outlet.

34. A system comprising:
a reservoir;
a residual solution in the reservoir, the residual solution formed from contact between an odorous effluent and a treatment solution comprising a scale inhibitor with a tracing agent and at least one component selected from the group consisting of a permanganate composition, a biocide, and an anti-foulant agent; and
a detection device in operative communication with the residual solution, the detection device detecting the tracing agent in the residual solution.

35. The system of claim 34 further comprising a scale inhibitor source in operative communication with the detection device, the detection device directing the scale inhibitor source to add the scale inhibitor to the treatment solution when the amount of the tracing agent in the residual solution is below a predetermined value.

36. The system of claim 34 further comprising an antifoulant agent source in operative communication with the detection device, the detection device directing the antifoulant agent source to add the antifoulant agent to the treatment solution when the amount of the tracing agent in the residual solution is below a predetermined value.

37. The system of claim 34 wherein the tracing agent is fluorescent, the detection device further comprising a fluorometer for detecting the fluorescence of the tracing agent.

38. A treatment method comprising:
contacting an odorous effluent with an aqueous solution comprising a scale inhibitor having a tracing agent and at least one component selected from the group consisting of an oxidant, a biocide, and an anti-foulant agent;
removing with the aqueous solution an odor component from the effluent;
collecting a residual solution; and
determining the amount of tracing agent present in the residual solution.

39. The method of claim 38 wherein tracing agent is fluorescent, the method further comprising
measuring the fluorescence of the tracing agent;
correlating the fluorescence to an amount of scale inhibitor in the residual solution; and
adding the scale inhibitor to the treatment solution when the amount of scale inhibitor falls below a predetermined value.

40. The method of claim 39 further comprising adding the antifoulant agent to the treatment solution when the amount of the scale inhibitor is below the predetermined value.
